(19) United States
(12) Patent Application Publication
(10) Pub. No.: US 2015/0095823 A1
(43) Pub. Date: Apr. 2, 2015

(54) MOBILE COMPUTING DEVICE INSTRUCTIONAL GRAPHICAL OVERLAY SYSTEMS AND RELATED METHODS

(71) Applicants: Assurant, Inc., Woodbury, MN (US); Mobile Defense, Inc., Cleveland, OH (US)

(72) Inventors: Dustin Brewer, Lakewood, OH (US); Stuart Saunders, Lakewood, OH (US); Cameron Hurst, Asheville, NC (US)

(21) Appl. No.: 14/505,241

(22) Filed: Oct. 2, 2014

Related U.S. Application Data
(60) Provisional application No. 61/885,535, filed on Oct. 2, 2013.

(51) Int. Cl. G06F 3/0482; G06F 3/0484

(52) U.S. Cl. CPC G06F 3/0482; G06F 3/04842
USPC 715/768; 715/790

(57) ABSTRACT

An instructional graphical overlay system is configured to overlay an instructional graphical overlay over an operating system, software application, or menu on a computing device to provide instructions or guidance to a user to complete a desired action using the computing device. In various embodiments, the system is configured to display a first graphical user interface and overlay a second instructional graphical user interface over at least a portion of the first graphical user interface. In some embodiments, the system is configured to enable the user to use the first graphical user interface to complete the desired action while the second instructional user interface is overlain over the first graphical user interface.

### BACKGROUND

Users of mobile computing devices may desire to troubleshoot their mobile computing device, set up one or more features of their mobile computing device, or perform other functions using their mobile computing device. It may be difficult for some users to undertake some of these activities, for example, due in part to the technical nature of the activities. Accordingly, there is a need for improved systems and methods for providing users of mobile computing devices with instructions for performing various functions on their mobile computing devices.

### SUMMARY

A computer system, according to various embodiments, comprises at least one processor. In particular embodiments, the computer system is configured for displaying, on a display associated with a computing device, a first graphical user interface; and selectively overlaying a second graphical user interface over at least a portion of the first graphical user interface. In some embodiments, the second graphical user interface comprises: one or more instructions for performing a particular action on the computing device; and a first user-selectable object. In various embodiments, the computer system is further configured for enabling a user to use the first graphical user interface to complete at least a first step of the one or more instructions; and enabling the user to select the first user-selectable object while the system is overlaying the second graphical user interface over the at least a portion of the first graphical user interface in order to facilitate completion, by the user, of the particular action.

A computer-implemented method of providing one or more instructions for performing a desired action on a mobile computing device, according to particular embodiments, comprises: (1) receiving a request to provide one or more instructions for performing the desired action on the mobile computing device; (2) at least partially in response to receiving the request, retrieving the one or more instructions and selectively overlaying an instructional graphical user interface over at least a portion of a graphical user interface displayed on a display of the mobile computing device, the graphical user interface being a user interface from which the user may perform one or more steps required to complete the desired action; and (3) facilitating completion of the desired action.

A non-transitory computer-readable medium, in various embodiments, stores computer-executable instructions for: (1) receiving a request, from a user of a mobile computing device comprising a display, to provide one or more instructions for performing a desired action on the mobile computing device; (2) at least partially in response to receiving the request, retrieving the one or more instructions; (3) at least partially in response to retrieving the one or more instructions, determining a first step of the one or more instructions; (4) at least partially in response to determining the first step of the one or more instructions, determining, based at least in part on the first step of the one or more instructions, an appropriate graphical user interface on the mobile computing device from which the user may complete the first step of the one or more instructions; (5) at least partially in response to determining the appropriate graphical user interface, displaying the appropriate graphical user interface on the display; (6) selectively overlaying an instructional graphical user interface over at least a portion of the appropriate graphical user interface; and (7) displaying the first step of the one or more instructions on the display via the instructional graphical user interface.

### BRIEF DESCRIPTION OF THE DRAWINGS

Various embodiments of a mobile computing device instructional graphical overlay system are described below. In the course of this description, reference will be made to the accompanying drawings, which are not necessarily drawn to scale, and wherein:

FIG. 1 is a block diagram of a mobile computing device instructional graphical overlay system in accordance with an embodiment of the present system;

FIG. 2 is a schematic diagram of a computer, such as the instructional information server of FIG. 1, that is suitable for use in various embodiments;

FIG. 3 depicts a flow chart that generally illustrates various steps executed by an Instructional Graphical Overlay Module that, for example, may be executed by the instructional information server of FIG. 1; and

FIGS. 4-22 are exemplary screen displays of the system according to various embodiments.

### DETAILED DESCRIPTION

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

In various embodiments, a mobile computing device instructional graphical overlay system is configured to provide a user of a mobile computing device (e.g., such as a smart phone, a tablet computer, a wearable computing device, a laptop computer, etc.) or other computing device with instructions, guidance, or other support in order to troubleshoot the mobile computing device, change one or more settings on the mobile computing device, configure one or more applications on the mobile computing device, or perform any other suitable action using the mobile computing device. In particular embodiments, the system is configured to overlay an instructional graphical user interface at least partially over an existing graphical user interface (e.g., such as an operating system, software application, settings menu, etc.) displayed on the mobile computing device. In various embodiments, the system is configured to guide the user through any particular task on a mobile computing device (e.g., or other computing device) for which the user may require assistance.

In various embodiments, the system is configured to: (1) receive, from a user, a request to provide one or more instructions for performing a desired action on a mobile computing device; (2) at least partially in response to receiving the request, retrieve the one or more instructions; and (3) at least partially in response to retrieving the one or more instructions, overlay at least a first portion of the one or more instructions on a graphical user interface displayed on the mobile computing device, the graphical user interface being a user interface from which the user may perform the desired action. In particular embodiments, the system is further configured to: (4) receive an indication that the user has completed the at least a first portion of the one or more instructions; and (5) at least partially in response to receiving the indication, overlay at least a second portion of the one or more instructions on the graphical user interface displayed on the mobile computing device. In particular embodiments, the system is configured to enable the user to follow a set of step-by-step instructions by, for example, overlaying the instructions in a step-by-step manner as the user completes each particular step.

In various embodiments, the overlain instructional graphical user interface comprises one or more instructions for completing one or more functions using the mobile computing device. In other embodiments, the overlain instructional graphical user interface comprises one or more indicia (e.g., one or more arrows, one or more highlights, etc.) that at least partially correspond to the one or more instructions and are configured to indicate to the user: (1) where on the existing graphical user interface the user should enter particular data to complete the one or more instructions; (2) a particular indicia or user-selectable object on the existing graphical user interface the user should select to complete a particular step of the one or more instructions; and/or (3) any other suitable information about the existing graphical user interface that may provide guidance to the user.

In various embodiments, the system is configured to overlay the one or more instructions to enable the user to, for example: (1) connect to and/or disconnect from a wireless network on the mobile computing device; (2) change one or more Access Point Name (APN) settings on the mobile computing device; (3) configure one or more e-mail accounts on the mobile computing device; (4) log into or out of an account associated with an application installed on the mobile computing device; (5) connect one or more devices (e.g., such as a keyboard, speaker, etc.) to the mobile computing device, for example, via Bluetooth; (6) import and/or export one or more contact lists to or from the mobile computing device; (7) share one or more pieces of media (e.g., one or more photographs, one or more videos, etc.) from the mobile computing device; (8) change one or more settings on the mobile computing device; and/or (9) perform any other suitable action on the mobile computing device.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus to create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

### Example System Architecture

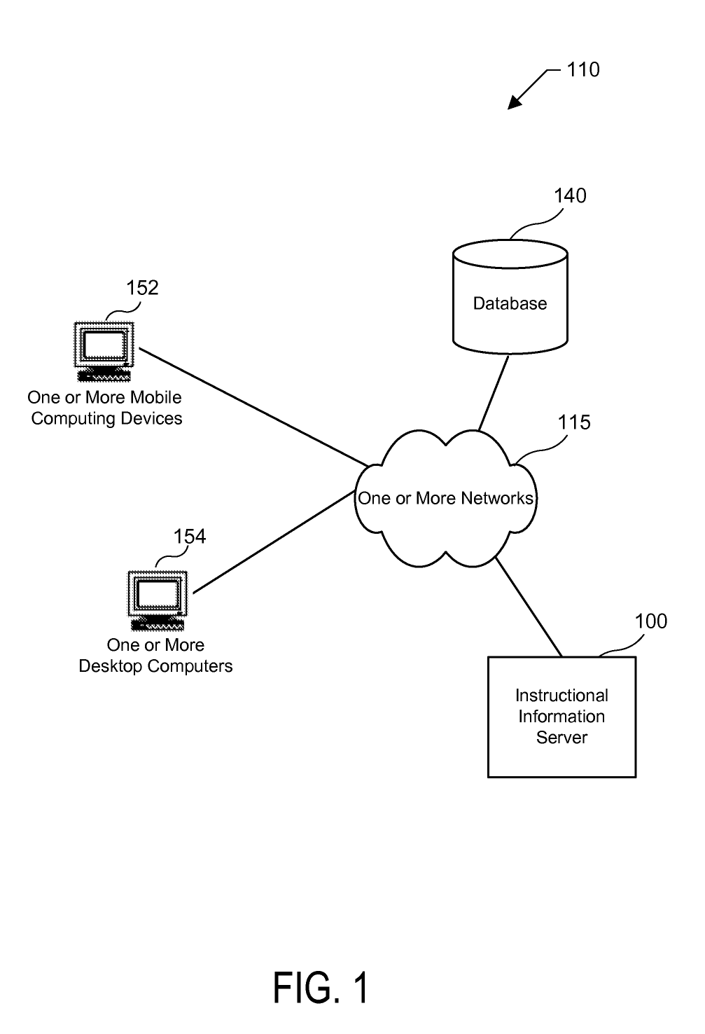

FIG. 1 is a block diagram of a System 110 according to a particular embodiment. As may be understood from this figure, the System 110 includes one or more computer networks 115, an Instructional Information Server 100, a Database 140, and one or more remote computing devices such as mobile computing device 156 (e.g., such as a smart phone, a tablet computer, a wearable computing device, a laptop computer, etc.) or a desktop computer 154. In particular embodiments, the one or more computer networks facilitate communication between the Instructional Information Server 100, Database 140, and one or more remote computing devices 152, 154.

The one or more computer networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computers). The communication link between Instructional Information Server 100 and Database 140 may be, for example, implemented via a Local Area Network (LAN) or via the Internet.

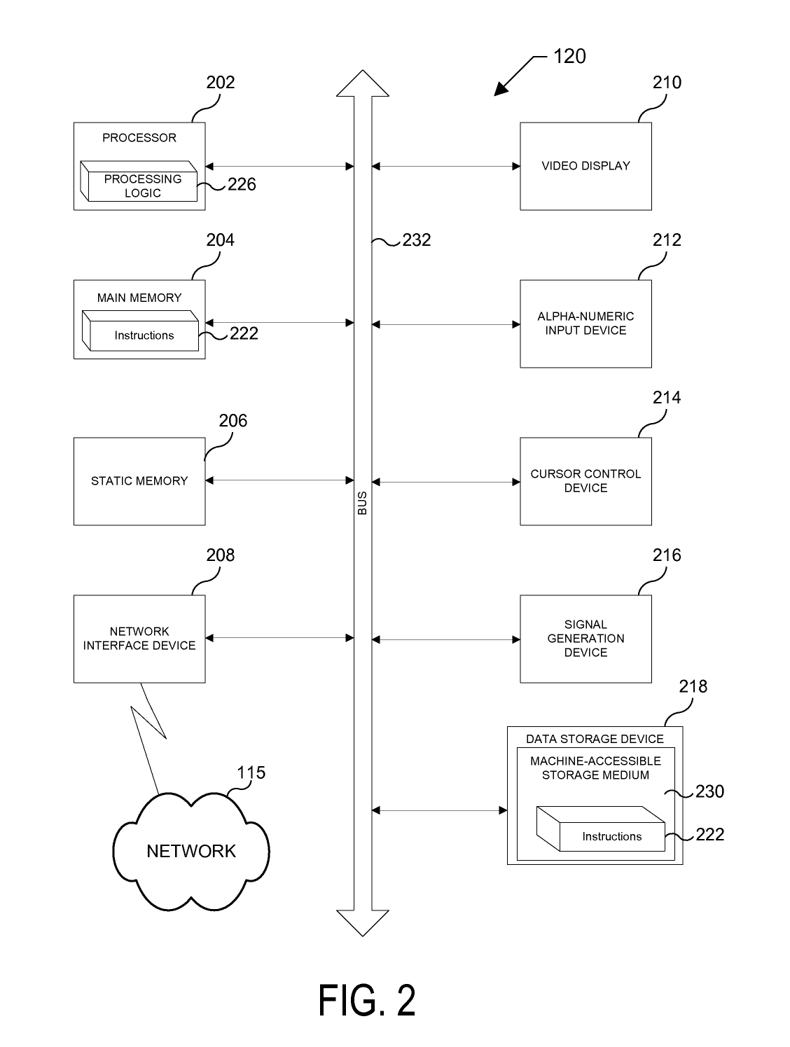

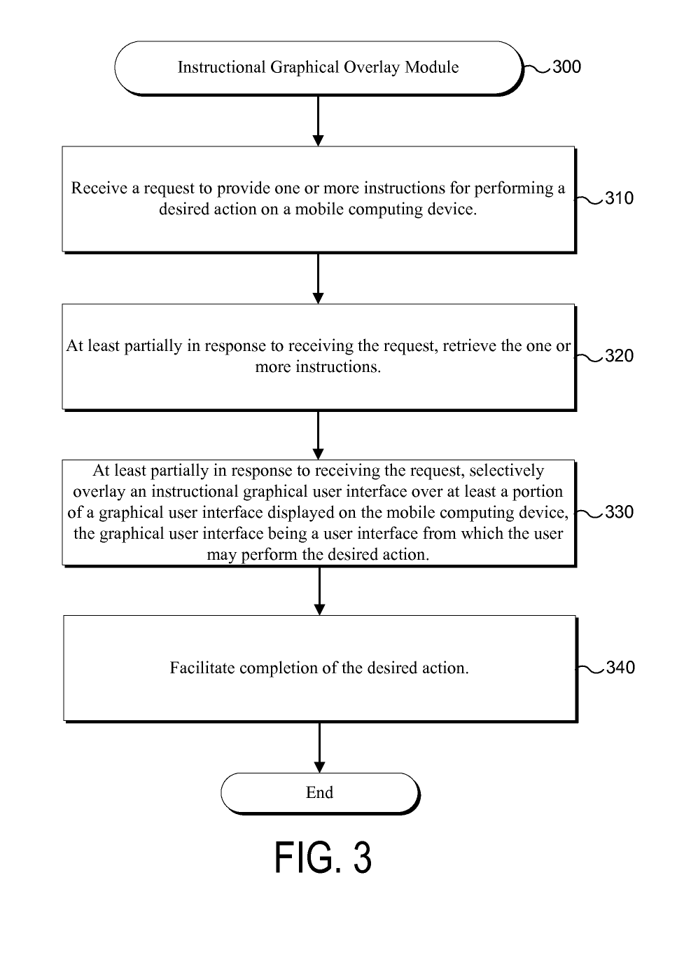

FIG. 2 illustrates a diagrammatic representation of a computer architecture 120 that can be used within the System 110, for example, as a client computer (e.g., one of client computers 152, 154 shown in FIG. 1), or as a server computer (e.g., Instructional Information Server 100 shown in FIG. 1). In particular embodiments, the computer 120 may be suitable for use as a computer within the context of the System 110 that is configured for collecting, tracking, and storing performance and Instructional Information for computing devices.

In particular embodiments, the computer 120 may be connected (e.g., networked) to other computers in a LAN, an intranet, an extranet, and/or the Internet. As noted above, the computer 120 may operate in the capacity of a server or a client computer in a client-server network environment, or as a peer computer in a peer-to-peer (or distributed) network environment. The Computer 120 may be a desktop personal computer (PC), a tablet PC, a set-top box (STB), a Personal Digital Assistant (PDA), a cellular telephone, a web appliance, a server, a network router, a switch or bridge, or any other computer capable of executing a set of instructions (sequential or otherwise) that specify actions to be taken by that computer. Further, while only a single computer is illustrated, the term “computer” shall also be taken to include any collection of computers that individually or jointly execute a set (or multiple sets) of instructions to perform any one or more of the methodologies discussed herein.

An exemplary computer 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose processing devices such as a microprocessor, a central processing unit, or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The computer 120 may further include a network interface device 208. The computer 120 also may include a video display unit 210 (e.g., a liquid crystal display (LCD) or a cathode ray tube (CRT)), an alphanumeric input device 212 (e.g., a keyboard), a cursor control device 214 (e.g., a mouse), and a signal generation device 216 (e.g., a speaker).

The data storage device 218 may include a non-transitory computer-readable storage medium 230 (also known as a non-transitory computer-readable storage medium or a non-transitory computer-readable medium) on which is stored one or more sets of instructions (e.g., software 222) embodying any one or more of the methodologies or functions described herein. The software 222 may also reside, completely or at least partially, within the main memory 204 and/or within the processing device 202 during execution thereof by the computer 120—the main memory 204 and the processing device 202 also constituting computer-readable storage media. The software 222 may further be transmitted or received over a network 115 via a network interface device 208.

While the computer-readable storage medium 230 is shown in an exemplary embodiment to be a single medium, the term “computer-readable storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding or carrying a set of instructions for execution by the computer and that cause the computer to perform any one or more of the methodologies of the present invention. The term “computer-readable storage medium” should accordingly be understood to include, but not be limited to, solid-state memories, optical and magnetic media, etc.

### Exemplary System Platform

Various embodiments of a mobile computing device instructional graphical overlay system may be implemented within the context of any suitable mobile computing device (e.g., such as a smart phone, a tablet computer, a wearable computing device, a laptop computer, etc.) or other computing device. In particular embodiments, the system may be implemented as part of an application on the mobile computing device, which the system may, for example, be configured to execute in the background of, or in unison with, one or more other software applications. Various aspects of the system's functionality may be executed by certain system modules, including an Instructional Graphical Overlay Module 300, which may, for example, be executed by a software application running on the mobile computing device or other computing device. Although this module is described below in the context of a mobile computing device, it should be understood that the module can be executed, in various embodiments, by any suitable computing device, such as, for example, a desktop computer, or other suitable computing device having at least one display (e.g., an electronic appliance, etc.). This module is discussed in greater detail below.

Instructional Graphical Overlay Module

When executing the Instructional Graphical Overlay Module 300, the system begins, at Step 310, by receiving a request to provide one or more instructions for performing a desired action on a mobile computing device. In various embodiments, the system is configured to receive the request from a user of a mobile computing device via a software application on the mobile computing device (e.g., a ‘help’ application). In a particular embodiment, the mobile computing device may have a software application stored on local memory associated with the mobile computing device. In other embodiments, the mobile computing device may be configured to access the software application from one or more remote servers via a suitable network. In some embodiments, the software application may be configured to enable the user to select from one or more sets of instructions for performing one or more actions on the mobile computing device. The system may then, in such an embodiment, receive the request at least partially in response to selection, by the user, of a particular one of the one or more sets of instructions in the software application. For example, in response to the user selecting a set of instructions for connecting to a wireless network, the system may receive the request to provide the one or more instructions for connecting to a wireless network.

In various embodiments, the system is configured to receive the request to provide one or more instructions at least partially in response to selection, by the user of the mobile computing device, of an on-screen indicia. In particular embodiments, the system is configured to display the on-screen indicia on at least a portion of a display screen associated with the mobile computing device. In a particular embodiment, the system is configured to overlay the on-screen indicia over at least a portion of a graphical user interface displayed on the mobile computing device. For example, the system may be configured to overlay the on-screen indicia over at least a portion of the graphical user interface for a particular software application on the mobile computing device while the mobile computing device is displaying the particular software application's graphical user interface on the mobile computing device's display screen.

As a particular example, while the user is accessing a “Settings” application (e.g., or settings menu) on the mobile computing device for configuring one or more mobile device settings, the system may be configured to overlay a ‘help’ indicia over the “Settings” application (e.g., in a corner of the display screen, in an upper or lower portion of the display screen, or in another suitable location). In various embodiments, the on-screen indicia may be sized and positioned in any suitable manner over the graphical user interface such that the on-screen indicia does not substantially interfere with the user's ability to use the particular software application. For example, in various embodiments, the system may be configured to size and position the on screen indicia such that the on-screen indicia does interfere with an ability of the user to select one or more selectable indicia on the particular software application's GUI, an ability of the user to read any text or view any images or video displayed on the software application's GUI (e.g., by positioning the on-screen indicia in a location that is not substantially on top of any text, image, or video), etc.

In various embodiments, the mobile computing device may comprise one or more user-selectable help buttons disposed in any suitable location on the mobile computing device (e.g., on any suitable outer portion of a casing of the mobile computing device). In such embodiments, the system may receive the request at least partially in response to the user pressing the one or more help buttons.

In particular embodiments, the system is configured to determine, based at least in part on what the system is currently displaying on the mobile computing device display (e.g., via the GUI), one or more potential actions for which the user may be requesting the one or more instructions in response to selection, by the user, of the help button or indicia. For example, the system may determine the one or more potential actions based at least in part on one or more menu choices currently displayed on the GUI, based on a particular software application currently running on the mobile computing device, etc. The system may then be configured to provide the user with a selection of the one or more potential actions and enable the user to select from the one or more actions. In such embodiments, the system may be configured to receive the request for the one or more instructions at least partially in response to selection, by the user, of the one or more potential actions.

In a particular example, the user may select the help button or indicia while accessing the mobile computing device's settings menu. The system may determine, at least partially in response to the user's request for help, that the user placed the request while viewing a connectivity menu from which a user may configure one or more WIFI or Bluetooth settings for the mobile computing device. At least partially in response to making this determination, the system may provide the user with a selection of one or more sets of instructions related to WIFI or Bluetooth (e.g., instructions for pairing a Bluetooth-enabled device with the mobile computing device, instructions for connecting to a secure wireless network, etc.).

In another particular example, the user may select the help button or indicia while using a particular software application on the mobile computing device (e.g., an e-mail application). The system may determine, at least partially in response to the user's request for help, that the user placed the request while using the e-mail application, and provide the user a selection of one or more sets of instructions related to the e-mail application (e.g., instructions for configured an e-mail account for use in the e-mail application, instructions for adding an attachment to an e-mail, etc.).

In various embodiments, the one or more instructions may comprise one or more step by step instructions for completing the desired action. In a particular embodiment, each particular step of the one or more step by step instructions may include, for example: (1) one or more instructions to select a particular indicia or user-selectable object (e.g., using a touch-screen display on the mobile computing device); (2) one or more instructions to provide one or more pieces of information (e.g., enter a username, network name, password, etc.); (3) one or more instructions to select one or more files (e.g., one or more video files, one or more image files, one or more comma-separated values file, etc.); and/or (4) one or more instructions to perform an other suitable action which may be required to complete the desired action. In still other embodiments, the one or more step by step instructions may include one or more instructions to interact with any object on the GUI in any other suitable manner.

Continuing at Step 320, the system, at least partially in response to receiving the request at Step 310, retrieves the one or more instructions. In various embodiments, the system is configured to retrieve the one or more instructions from one or more local data stores associated with the mobile computing device. In other embodiments, the system is configured to retrieve the one or more instructions from one or more remote data stores (e.g., one or more remote servers), for example, via any suitable network (e.g., a suitable wireless network, a suitable cellular network, etc.).

In still other embodiments, the system is configured to retrieve the one or more instructions from any suitable source. For example, in various embodiments, the system is configured to retrieve the one or more instructions from: (1) a maker of a particular application to which the one or more instructions apply; (2) one or more databases of user-submitted instructions; and/or (3) from any other suitable source. In particular embodiments, the system is configured to receive one or more sets of one or more instructions from an instructions provider such as an individual user (e.g., a particular user may provide a walkthrough or set of instructions for performing a particular task on the mobile computing device), a publisher of a particular software application, a creator of a particular operating system, one or more wireless internet providers, one or more hardware manufacturers (e.g., who may provide one or more instructions for connecting, using, etc. the mobile computing device with one or more pieces of hardware that the one or more hardware manufacturers manufacture), etc. In such embodiments, the system may be configured to store the one or more received instructions (e.g., in a suitable data store such as on one or more servers, etc.) for future retrieval.

Returning to Step 330, the system continues by, at least partially in response to receiving the request, selectively overlaying an instructional graphical user interface over at least a portion of a graphical user interface displayed on the mobile computing device. In particular embodiments, the graphical user interface (GUI) is any suitable GUI for allowing the user to interact with (e.g., provide commands to, view data on, etc.) the mobile computing device. In various embodiments, the graphical user interface is a user interface from which the user may perform the desired action (e.g., a user interface which the user may use to perform the desired action). In particular embodiments, the graphical user interface may include any suitable graphical user interface for, for example, a software application or feature thereof, an operating system, a menu, a submenu, or other suitable graphical user interface for which the user has requested the one or more instructions.

In particular embodiments, the system is configured to display the graphical user interface at least partially in response to receiving the request to provide the one or more instructions. For example, in embodiments in which the user has requested the one or more instructions via a suitable instructions application (e.g., by opening the help application on the mobile computing device and selecting a particular set of instructions, pressing a help button on the mobile computing device, etc.), the system may be configured to: (1) display a graphical user interface on the mobile computing device's display (e.g., by opening a software program for which the user has requested the one or more instructions, by opening a settings menu from which the user can change one or more settings for which the user has requested the one or more instructions, etc.); and (2) selectively overlay the instructional graphical user interface over at least a portion of the first graphical user interface.

In various embodiments, the instructional graphical user interface comprises one or more instructions for, for example, modifying one or more settings on the mobile computing device (e.g., to solve one or more particular performance issues associated with the mobile computing device). In other embodiments, the instructional graphical user interface comprises one or more instructions for performing a particular action within a particular software application (e.g., adding or removing a friend from a social networking application, making any suitable change to a fantasy sports team using a fantasy sports application, performing any suitable banking activity using a suitable banking application, or any other suitable activity which a user can perform using any particular software application on the mobile computing device for which the user may require instructions).

In particular embodiments, they system is configured to overlay the instructional graphical user interface over at least a portion of the graphical user interface displayed on the mobile computing device's display. For example, the system may be configured to overlay the instructional GUI over any suitable portion of the GUI (e.g., an upper portion, lower portion, side portion, corner, etc.). In various embodiments, the instructional GUI may be at least partially transparent (e.g., such that the GUI is at least partially visible below the instructional GUI). In various embodiments, the system is configured to enable the user to: (1) adjust a position of one or more elements of the instructional GUI; (2) selectively view or hide the instructional GUI or any suitable portion of the instructional GUI; (3) interact with the at least a portion of the GUI over which the instructional GUI is overlain (e.g., the system may enable the user to select or otherwise interact with an indicia, user-selectable object, or other object on the GUI that is at least partially behind the instructional GUI); (4) selectively adjust a size of the instructional GUI (e.g., by selectively minimizing or collapsing the instructional GUI to selectively hide or display at least a portion of the instructional GUI); (5) etc.

In some embodiments, the system is configured to display a particular step of the one or more instructions via the instructional GUI and enable the user to hide at least a portion of the instructional GUI while the user completes the particular step. For example, the system may hide a portion of the instructional GUI at the request of the user to enable the user a better view of the GUI that the user is using to complete the particular step.

In particular embodiments, the instructional GUI includes one or more textual instructions, one or more images, one or more videos, one or more indicators (e.g., arrows, highlights, lines, shapes, etc.), and/or any other suitable feature which may provide guidance to the user to complete the desired action for which the user has requested the one or more instructions. For example, the instructional GUI may include a written description of the one or more instructions (e.g., ‘click here’, ‘select this indicia’, ‘enter username here’, etc.); an arrow, highlight, or other visual indicator that at least partially corresponds to the written description (e.g., an arrow pointing to the indicia, a box around a text box in which the user should enter their username, etc.); and any other suitable visual indicators that may provide guidance to the user in completing the desired action. In various embodiments the one or more indicators at least generally correspond to the written description of the one or more instructions.

Returning to Step 340, the system continues by facilitating completion of the desired action. In particular embodiments, the system is configured to facilitate completion of the desired action by substantially automatically guiding the user through each particular step required to complete the desired action in a substantially step by step manner. In a particular embodiment, the system is configured to display one or more instructions on the instructional GUI to complete a first step of the one or more instructions for completing the desired action. The system, in such an embodiment, may be further configured to: (1) determine whether the user has completed the first step; (2) at least partially in response to determining that the user has completed the first step, display one or more instructions on the instructional GUI to complete a second step of the one or more instructions for completing the desired action; and (3) so on until the system determines that the user has completed each particular step of the one or more instructions for completing the desired action. In various embodiments, the system is configured to substantially automatically determine that the user has completed a particular step of the set of instructions. In other embodiments the system is configured to determine that the user has completed the particular step in response to input from the user (e.g., in response to the user electing a user-selectable object to indicate their completion, in response to the user scrolling to the next particular step, etc.).

In particular embodiments, the system is further configured to facilitate completion of the desired action by substantially automatically navigating the mobile computing device to a suitable GUI from which the user may complete a particular step of the one or more instructions. In various emboldens, the system is configured to: (1) determine the suitable GUI based at least in part on the particular step; (2) display the suitable GUI on the mobile computing device display; (3) overlay the instructional GUI over at least a portion of the suitable GUI; and (4) facilitate complete of the particular step. In such embodiments, in response to determining that the user has completed the particular step, the system is configured to continue to the next particular step, determine the suitable GUI for the next particular step, etc. In some embodiments, the user may be able to complete the one or more instructions substantially from a single GUI. In other embodiments, a particular set of instructions may include one or more steps that require the user to user a plurality of GUIs.

For example, in the case of a menu that comprises more options than the mobile computing device is configured display at once (e.g., sufficient options that the user may need to scroll down to view all of the menu options), the system may substantially automatically scroll to the portion of the menu that includes the particular option that the user needs to select to complete the particular step. In another example, for a set of instructions that requires the user to perform one or more actions in one or more different software programs, one or more different menus, etc., the system may substantially automatically display the GUI for the particular one of the one or more software programs or menus from which the user can complete a particular step as the system is providing the one or more instructions for that particular step.

### Exemplary User Experience

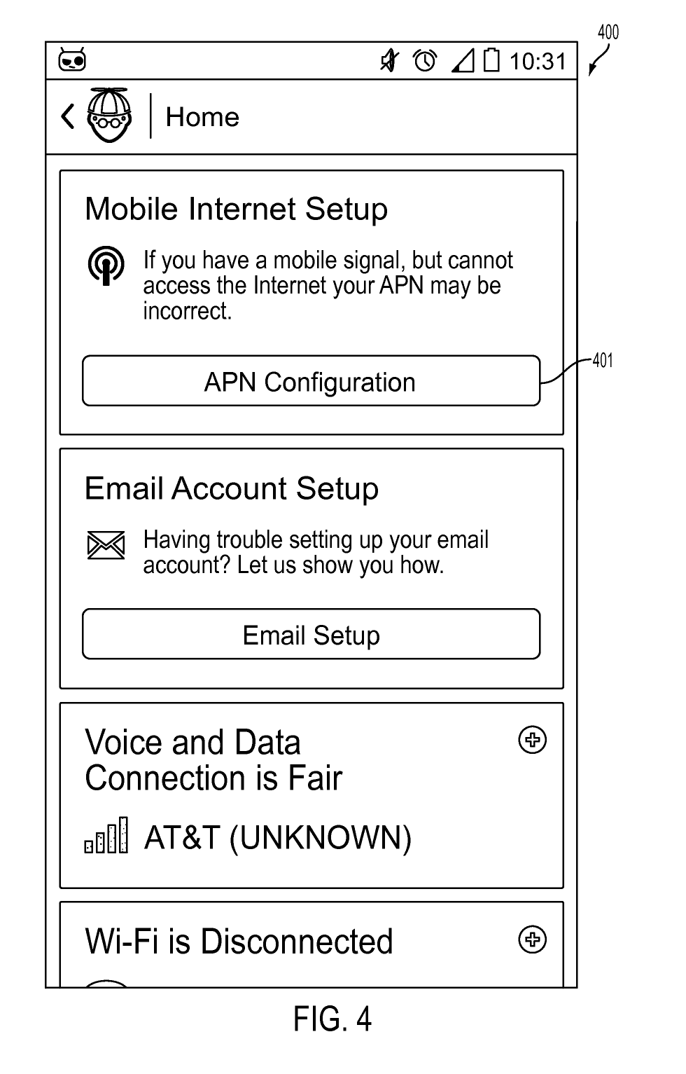

FIGS. 4-22 depict exemplary screen displays that a user may encounter when using a particular embodiment of the graphical overlay instruction system. As may be understood from these figures, the user may utilize the system to receive step by step instructions for completing a particular action on a computing device such as a mobile computing device. These figures depict a particular example of a user's experience using the system to provide instructions for configuring an Access Point Name (APN) on a smartphone.

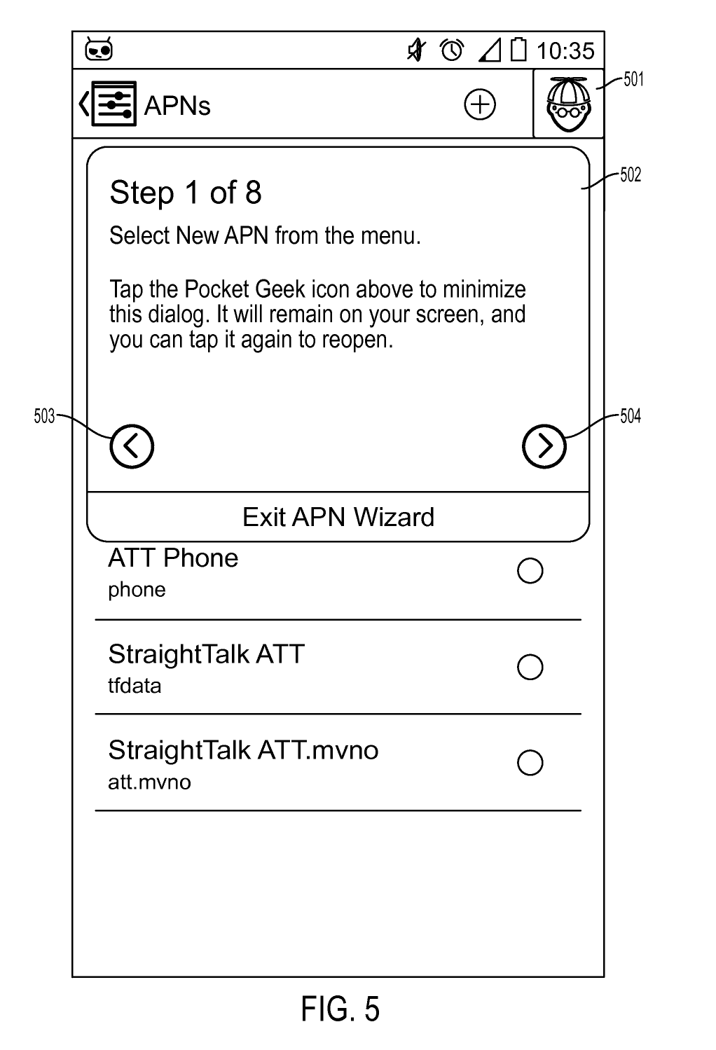

FIG. 4 depicts an exemplary user interface 400 for modifying one or more settings on the user's smart phone. In order to configure the APN, the user may select the APN Configuration 401 user-selectable object. In response to the selection, as shown in FIG. 5, the system may display an APN configuration menu (e.g., via an APN configuration GUI) and overlay an instructional GUI 502 that provides written instructions for completing the APN configuration. As shown in this figure, the APN Configuration requires eight steps that the user must complete to configure the APN. In this embodiment, the instructional GUI comprises a forward 504 and back 503 user-selectable object that the user may select to cycle forwards and backwards between the eight steps. The instructional GUI further comprises a collapse button 501, which the user may select to collapse the instructional GUI to view the portions of the APN configuration menu obstructed by the overlain instructional GUI. As shown in this figure, the first step requires the user to select a new APN.

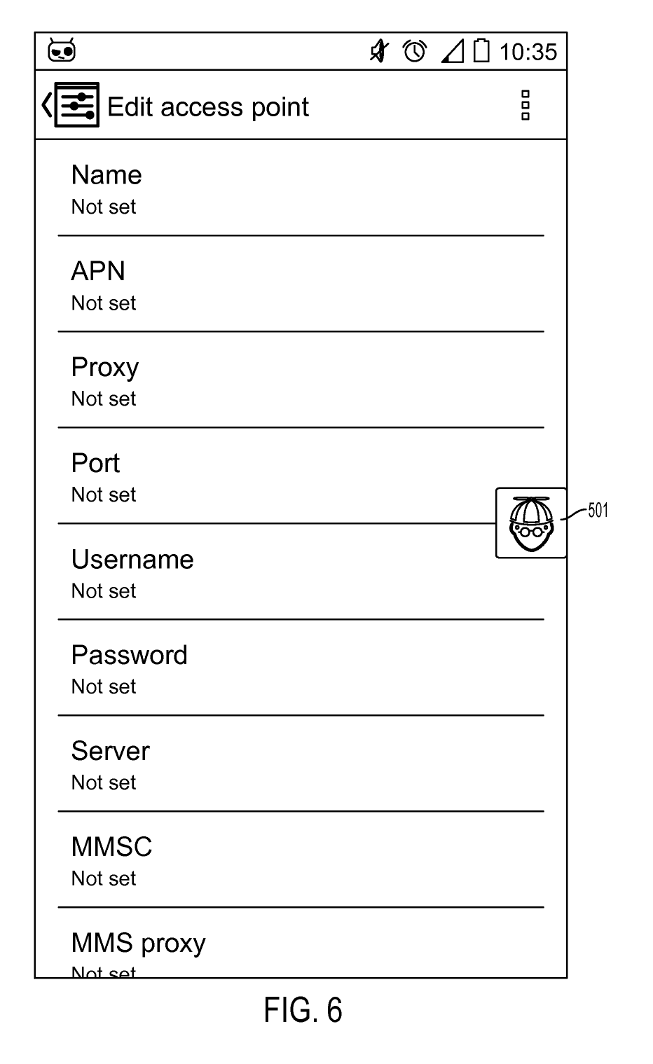

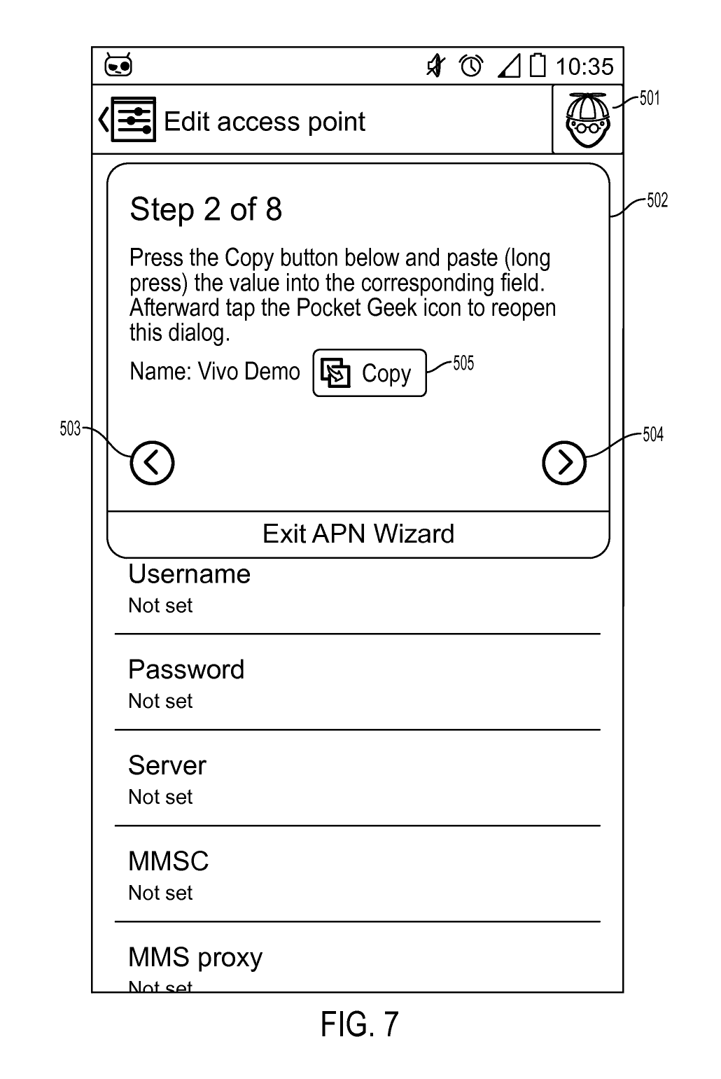

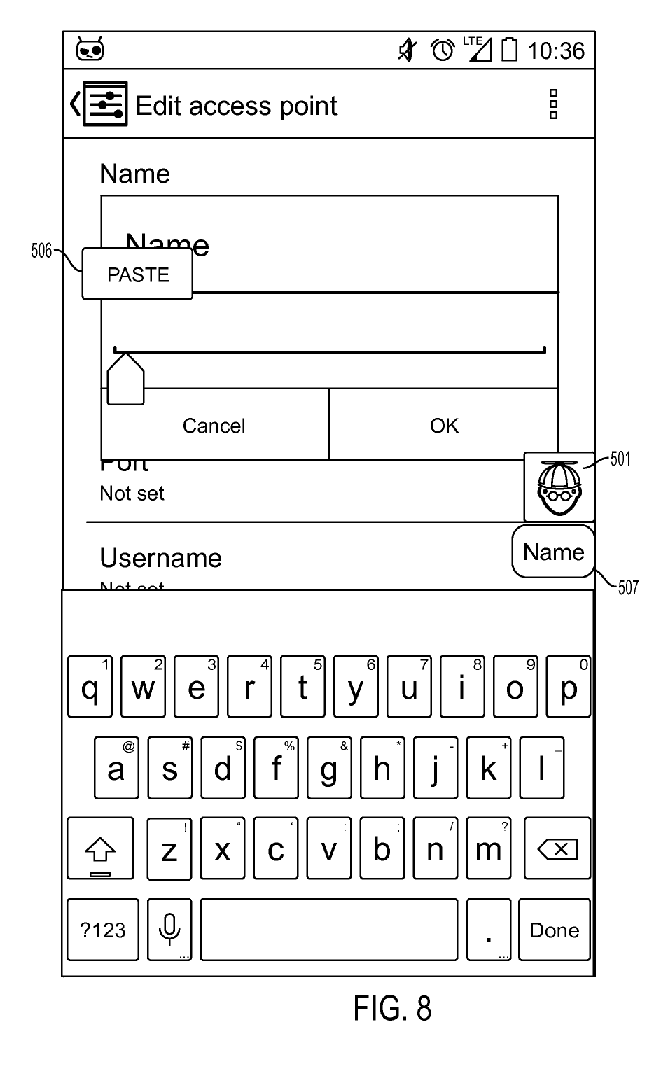

FIG. 6 depicts the APN configuration menu with the instructional GUI collapsed. As may be understood from this figure, the user may select the collapse button 501 to expand the instructional GUI and review the written instructions if needed. FIG. 6 depicts various information the user may need to provide to configure the new APN such as, for example, name, APN, Proxy, Username, etc. Continuing to Step two in FIG. 7, the instructional GUI 502 instructs the user to copy 505 the provided name (‘Vivo Demo’) and paste the name into the Name field on the APN configuration menu shown in FIG. 8. As may be understood from FIG. 7, in some embodiments, after copying the Name, the user may press the collapse button 501 to select and access the Name field. In other embodiments, the system may substantially automatically open the Name field in response to the user copying the name. In some embodiments, the one or more instructions may provide the value that the user must input into a particular field and enable the user to copy and paste the value. In other embodiments, the user may provide the value.

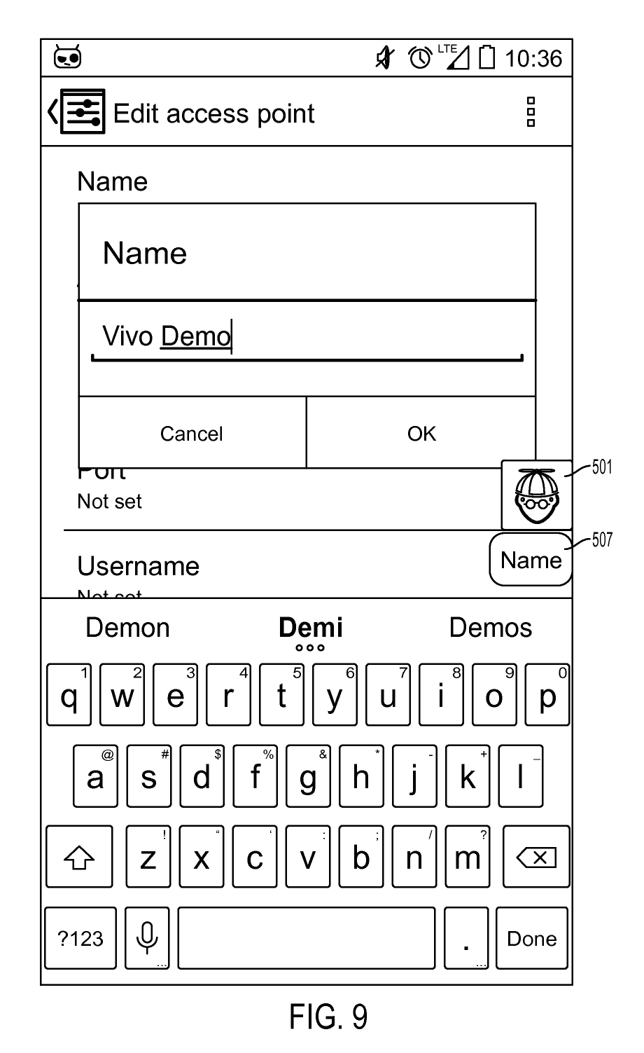

FIG. 8 depicts the Name field where the user can paste 506 the name (‘Vivo Demo’) copied from the previous instruction. As shown in this figure, the instructional GUI may include a topic name 507 (Name) for the current instruction while the instructional GUI has been collapsed. In various embodiments, this may provide guidance to the user about the particular step they are currently performing. The user may select the collapse button 501 to expand the instructional GUI and view the full description of the step if they so desire. FIG. 9 depicts the Name field with the Name (‘Vivo Demo’) following pasting of the name by the user.

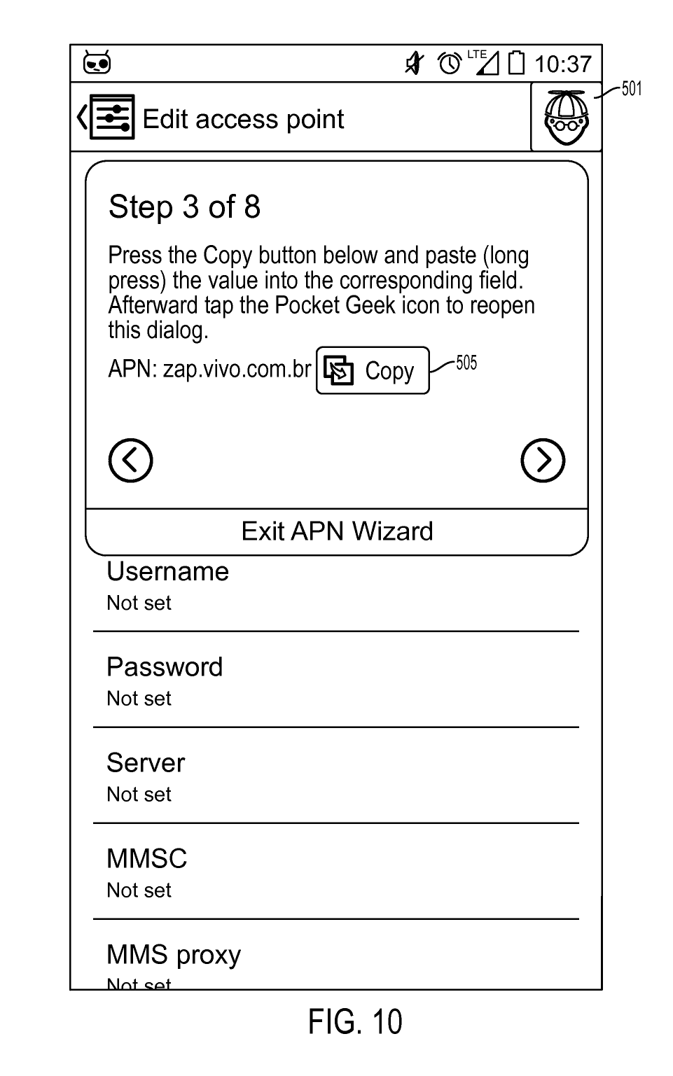

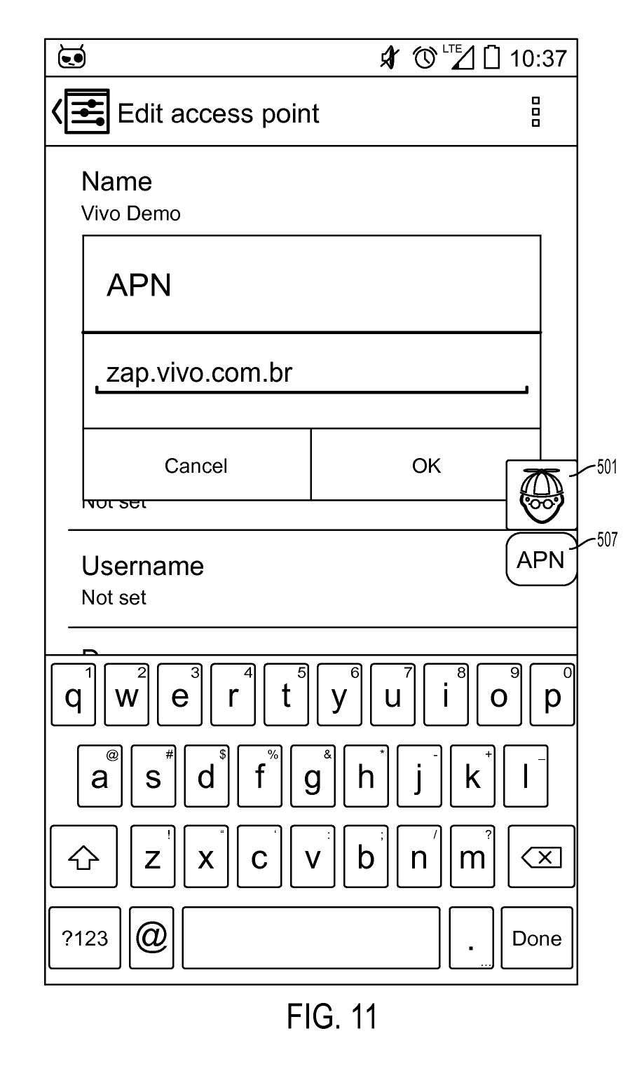

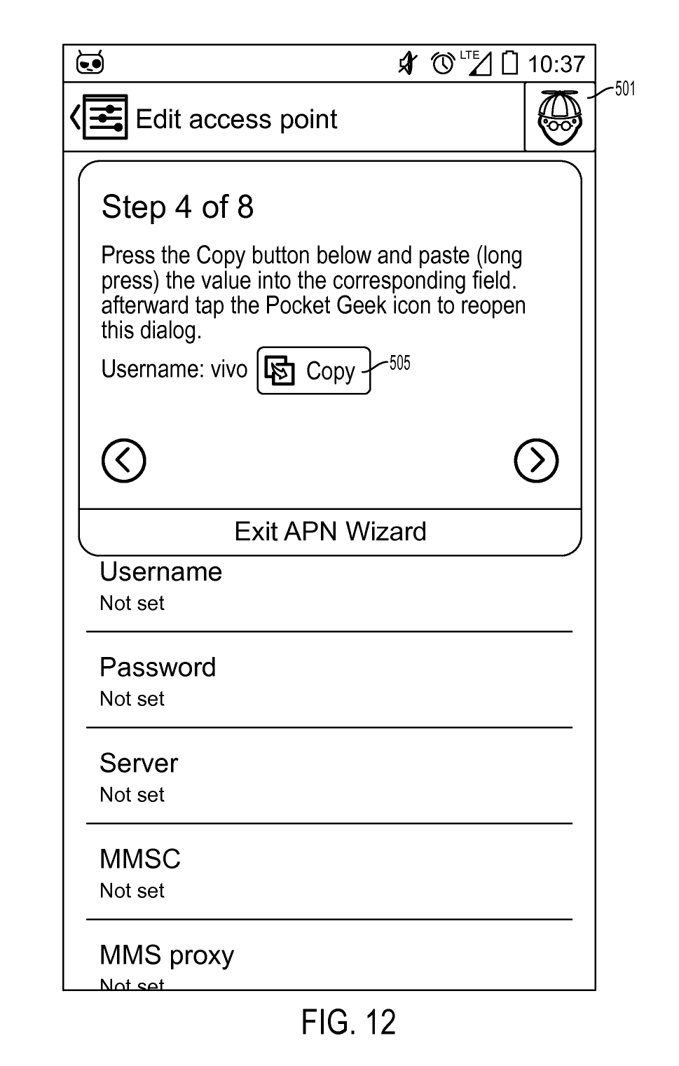

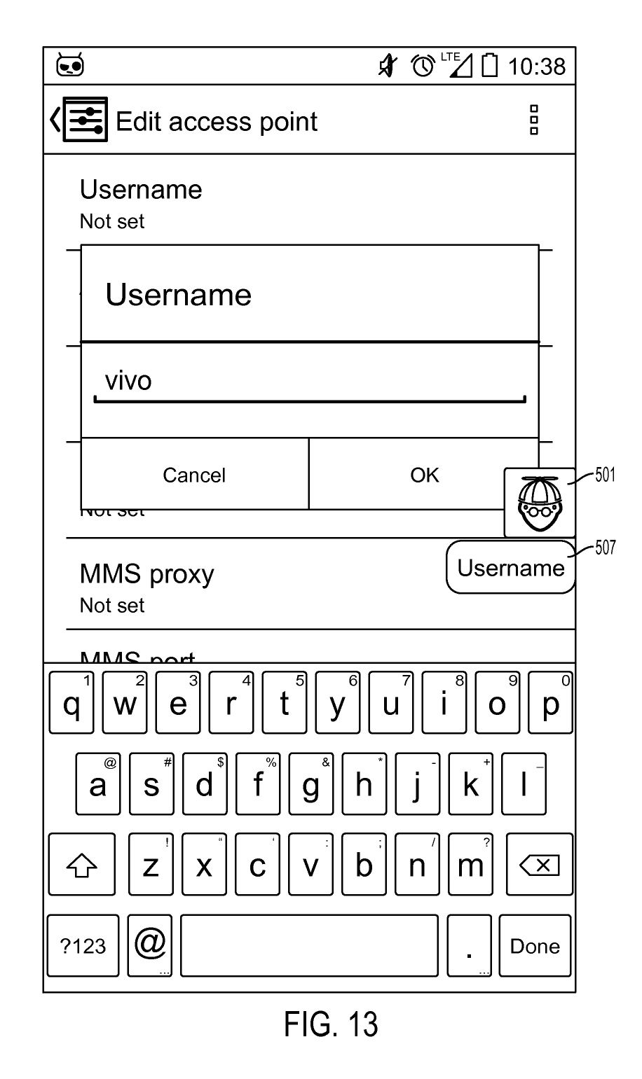

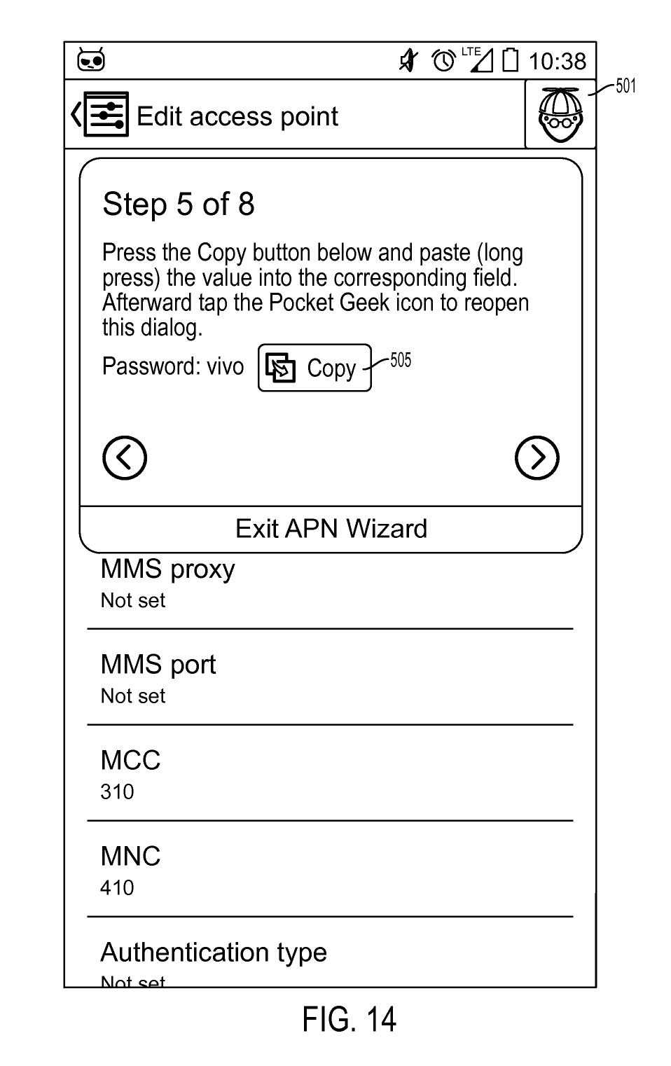

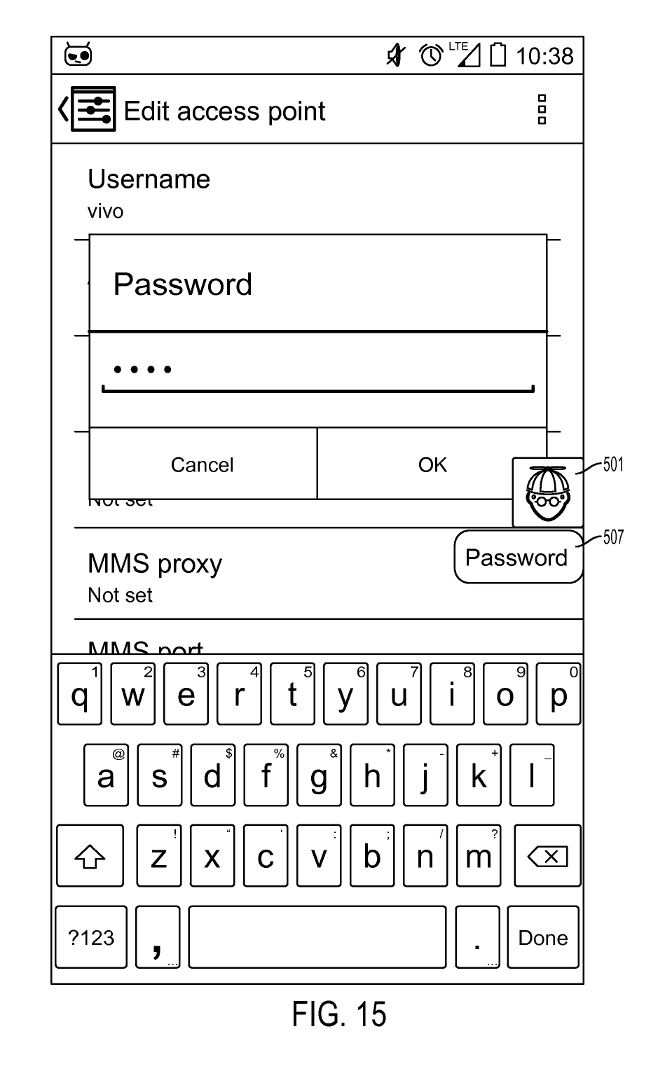

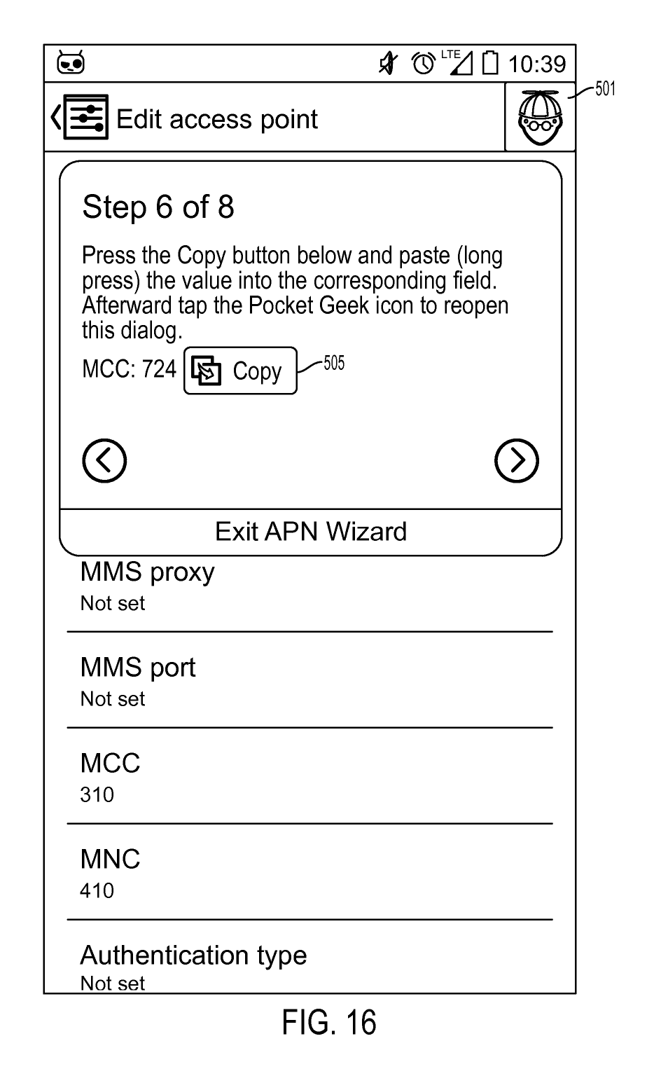

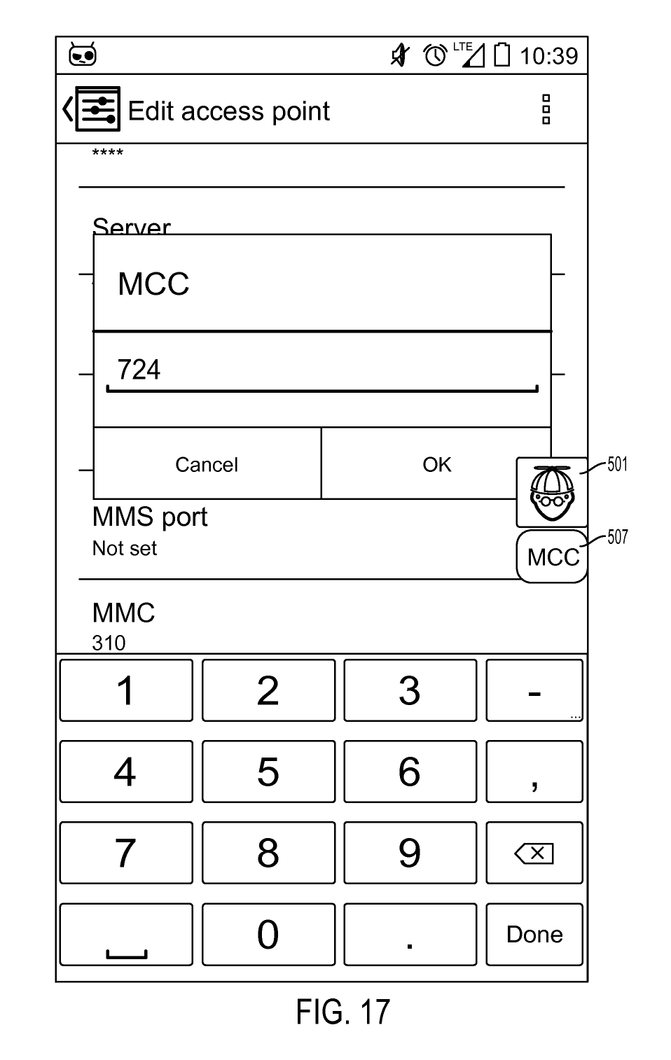

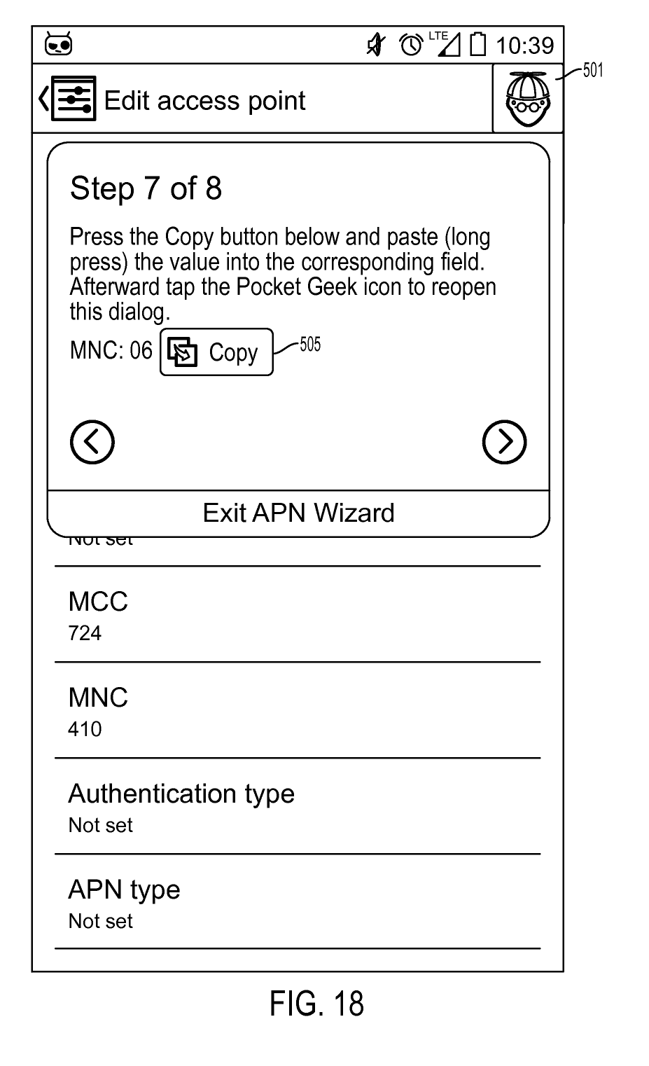

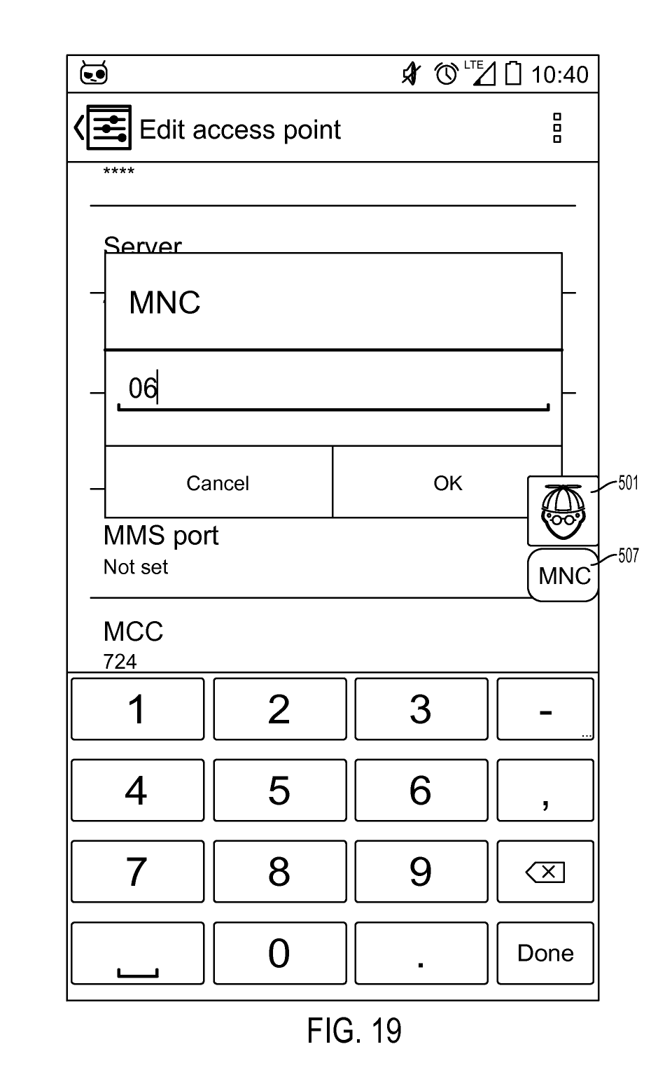

Continuing to FIG. 10, the system is displaying Step 3 in the instructional GUI, which includes entry of the APN by the user. Here, as above, the user may copy 505 and paste the APN (‘zap.vivo.com.br’) into the APN field in FIG. 11 as shown. Continuing to FIG. 12, the user can complete step 4 by copying the username (‘vivo’) and pasting it into the Username field as shown in FIG. 13. As shown in FIG. 14, the user can copy 505 the password (‘vivo’) and paste it into the password field in FIG. 15 to complete step 5. Continuing to step 6, the user can copy 505 the mobile country code (MCC) as shown in FIG. 16 and enter it in the MCC filed as shown in FIG. 17. FIG. 18 shows Step 7 of the instructions where the user can copy 505 the mobile network code (MNC) and paste it in the MNC field as shown in FIG. 19.

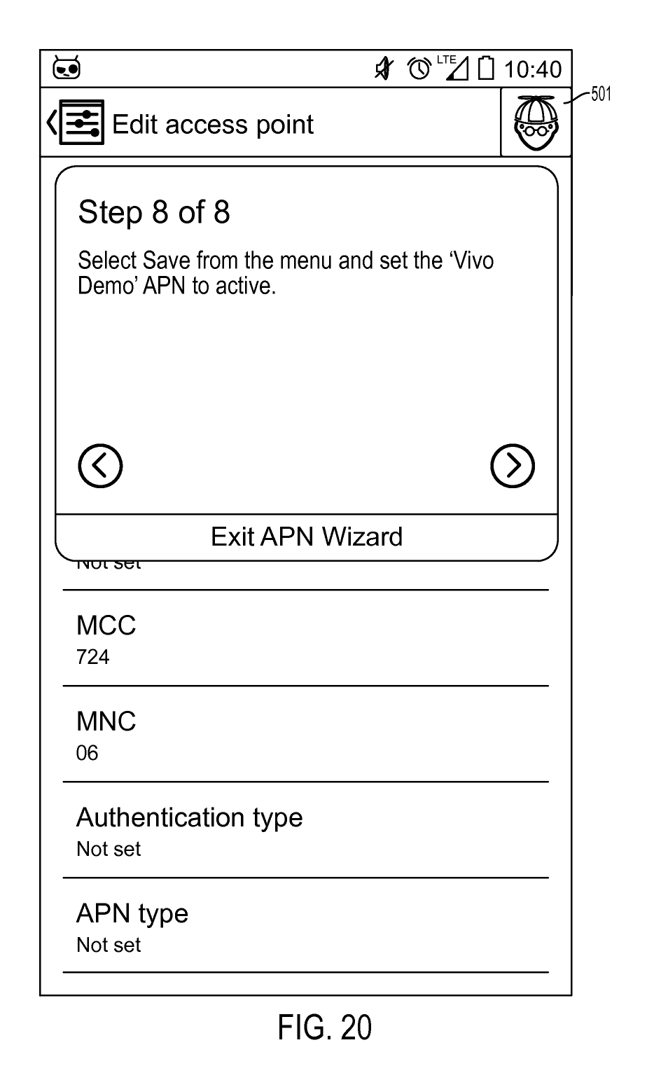

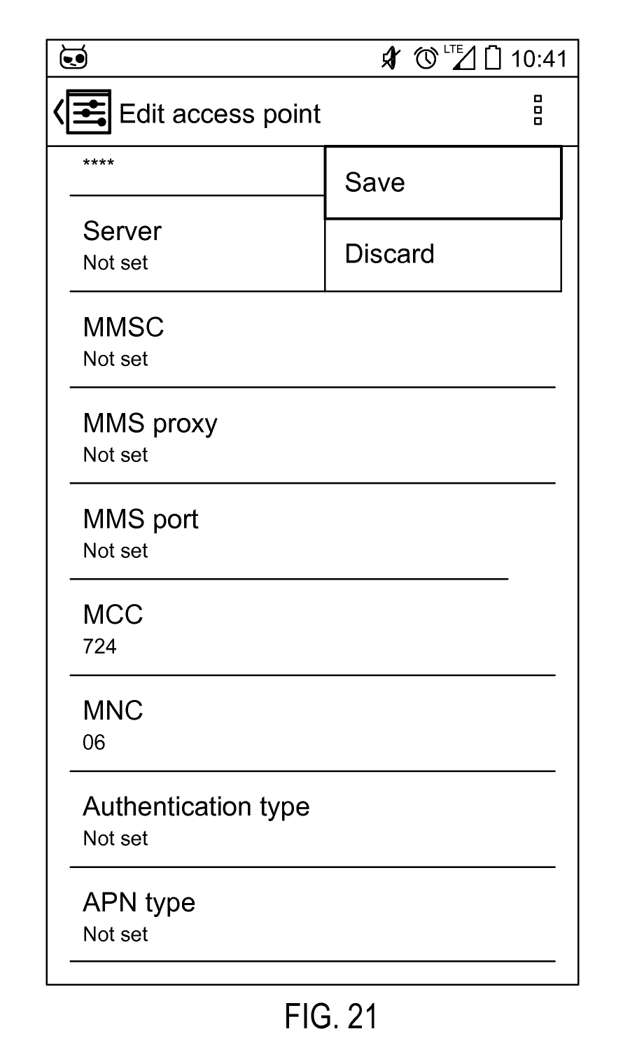

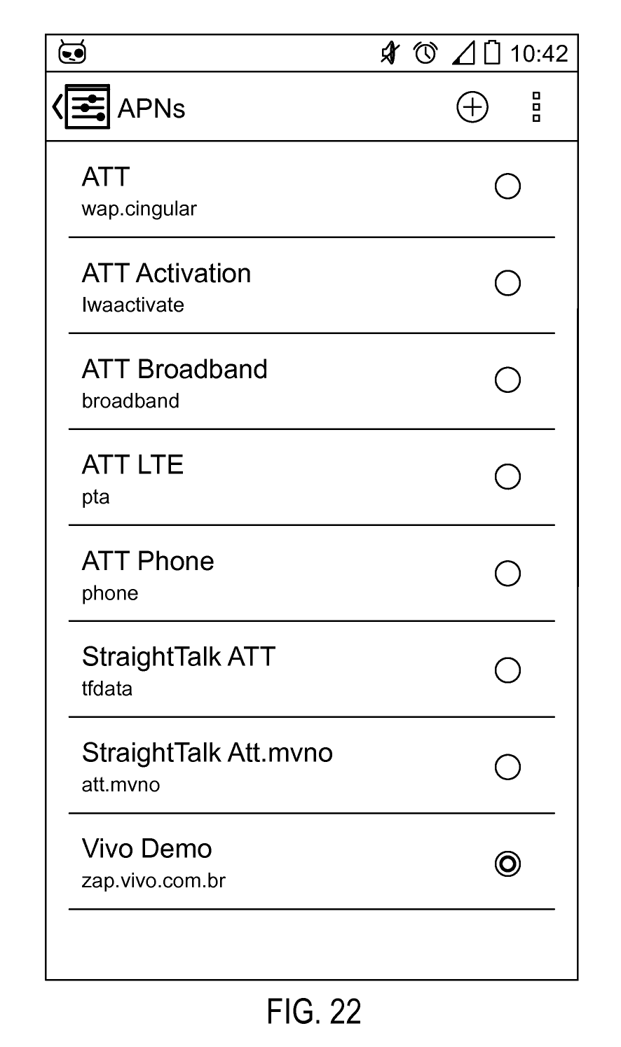

FIG. 20 depicts Step 8 of the instructions, which tell the user to select save from the menu and set the ‘Vivo Demo’ APN that was just created to active. FIG. 21 depicts a menu from which the user can select to save the newly created APN. In this embodiment, the save button is highlighted with a thicker border than the discard button to indicate to the user where to select the save button. After the user selects save in FIG. 21, the system directs the user to the interface shown in FIG. 22 from which the user can select the Vivo Demo APN. In various embodiments, the system may substantially automatically select the Vivo Demo APN for the user.

### Alternative Embodiments

Various embodiments of an instructional graphical overlay system may include one or more features in addition to those features described above. For example, in a particular embodiment, the system is configured to determine the user's ability to complete the one or more constructions (e.g., particular steps of the one or more instructions) and dynamically modify the one or more instructions based at least in part on the user's determined ability. The system may, for example, determine that the user requires more or less detailed instructions to perform a particular action on the mobile computing device. The system may determine the user's ability, for example, based at least in part on: (1) an amount of time the system determines that the user takes to complete a particular step of the instructions after the system displays the particular step to the user; (2) a number of times the system determines the user does not successfully complete one or more particular steps; (3) a request form the user to provide more or less detailed instructions; (4) etc.

In some embodiments, the system is configured to determine (e.g., detect) one or more substantially current conditions, settings, etc. of the mobile computing device. The system may then be configured to dynamically alter the one or more instructions based at least in part on the one or more conditions or settings. In a particular embodiment, the system may be configured to, for example: (1) determine one or more settings of the mobile computing device; (2) determine, based in part on the one or more settings and the one or more instructions, whether the one or more instructions contain one or more unnecessary steps to change one or more mobile computing device settings to a setting to which the one or more settings are already set; and (3) remove the one or more unnecessary steps from the one or more instructions. In such embodiments, the system may omit displaying particular steps from a set of instructions to the user, where those particular steps: (1) have already been completed prior to the user requesting help; (2) are unnecessary because the mobile computing device is already in a condition that would result from the user completing the particular step; and/or (3) for any other suitable reason.

### CONCLUSION

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer system comprising:
at least one processor, wherein the computer system is configured for:
displaying, on a display associated with a computing device, a first graphical user interface;
selectively overlaying a second graphical user interface over at least a portion of the first graphical user interface, the second graphical user interface comprising:
one or more instructions for performing a particular action on the computing device; and
a first user-selectable object;
enabling a user to use the first graphical user interface to complete at least a first step of the one or more instructions; and
enabling the user to select the first user-selectable object while the system is overlaying the second graphical user interface over the at least a portion of the first graphical user interface in order to facilitate completion, by the user, of the particular action.

2. The computer system of claim 1, wherein the computer system is further configured for:
determining that the user has selected the first user-selectable object; and
at least partially in response to determining that the user has selected the first user-selectable object, collapsing at least a portion of the second graphical user interface.

3. The computer system of claim 2, wherein:
the second graphical user interface comprises a second user-selectable object and the computer system is further configured for:
displaying, via the second graphical user interface, the first step of the one or more instructions;
determining that the user has selected the second user-selectable indicia; and
at least partially in response to determining that the user has selected the second user-selectable object, displaying, via the second graphical user interface, a second step of the one or more instructions.

4. The computer system of claim 3, wherein:
the computer system is further configured for:
determining, based at least in part on the second step of the one or more instructions and the first graphical user interface, whether the user can complete the second step of the one or more instructions via the first graphical user interface;
at least partially in response to determining that the user cannot complete the second step of the one or more instructions via the first graphical user interface:
displaying a third graphical user interface on the display associated with the computing device; and
selectively overlaying the second graphical user interface over at least a portion of the third graphical user interface; and
enabling the user to use the third graphical user interface to complete at least the second step of the one or more instructions.

5. The computer system of claim 4, wherein the particular action comprises changing one or more settings on the computing device.

6. The computer system of claim 1, wherein:
at least a portion of the second graphical user interface is at least partially transparent such that the user may view both the second graphical user interface and first graphical user interface while the computer system is selectively overlaying the second graphical user interface over the at least a portion of the first graphical user interface.

7. A computer-implemented method of providing one or more instructions for performing a desired action on a mobile computing device, the method comprising:
receiving, by a processor, a request to provide one or more instructions for performing the desired action on the mobile computing device;
at least partially in response to receiving the request:
retrieving, by a processor, the one or more instructions;
selectively overlaying an instructional graphical user interface, by a processor, over at least a portion of a graphical user interface displayed on a display of the mobile computing device, the graphical user interface being a user interface from which the user may perform one or more steps required to complete the desired action; and
facilitating completion, by a processor, of the desired action.

8. The computer-implemented method of claim 9, wherein:
facilitating completion of the desired action comprises displaying, via the instructional graphical user interface, one or more first steps of the one or more instructions.

9. The computer-implemented method of claim 8, wherein:
facilitating completion of the desired action further comprises:
determining whether the user has completed the one or more first steps; and
at least partially in response to determining that the user has completed the one or more first steps:
removing the one or more first steps from the instructional graphical user interface; and
displaying, via the instructional graphical user interface, one or more second steps of the one or more instructions.

10. The computer-implemented method of claim 9, wherein:
facilitating completion of the desired action comprises:
determining a second graphical user interface for completing the one or more second steps based at least in part on the one or more second steps;
at least partially in response to determining the second graphical user interface:
displaying the second graphical user interface on the display of the mobile computing device; and
selectively overlaying the instructional graphical user interface over at least a portion of the second graphical user interface.

11. The computer-implemented method of claim 7, wherein:
the computer-implemented method further comprises:
displaying, by a processor, the graphical user interface on the display; and
selectively overlaying, by a processor, the instructional graphical user interface over at least a portion of the graphical user interface, the instructional graphical user interface comprising a user-selectable instruction request object; and
receiving the request to provide the one or more instructions comprises receiving an indication that the user has selected the user-selectable instruction request object.

12. The computer-implemented method of claim 11, wherein:
the computer-implemented method further comprises:
at least partially in response to receiving the indication that the user has selected the user-selectable instruction request object, determining, by a processor, based at least in part on the graphical user interface, one or more potential actions for which the user may have requested instructions; and
at least partially in response to determining the one or more potential actions, enabling, by a processor, the user to select a particular one of the one or more potential actions; and
receiving the request to provide the one or more instructions comprises receiving, from the user, a selection of the particular one of the one or more potential actions.

13. The computer-implemented method of claim 12, wherein:
the graphical user interface comprises a settings menu interface; and
the desired action comprises modifying one or more settings on the computing device.

14. The computer-implemented method of claim 13, wherein:
the one or more settings are selected from a group consisting of:
i. one or more access point name settings; and
ii. one or more WIFI settings.

15. A non-transitory computer-readable medium storing computer-executable instructions for:
receiving a request, from a user of a mobile computing device comprising a display, to provide one or more instructions for performing a desired action on the mobile computing device,
at least partially in response to receiving the request, retrieving the one or more instructions;
at least partially in response to retrieving the one or more instructions, determining a first step of the one or more instructions;
at least partially in response to determining the first step of the one or more instructions, determining, based at least in part on the first step of the one or more instructions, an appropriate graphical user interface on the mobile computing device from which the user may complete the first step of the one or more instructions;
at least partially in response to determining the appropriate graphical user interface, displaying the appropriate graphical user interface on the display;
selectively overlaying an instructional graphical user interface over at least a portion of the appropriate graphical user interface; and
displaying the first step of the one or more instructions on the display via the instructional graphical user interface.

16. The non-transitory computer-readable medium of claim 15, wherein:
the instructional graphical user interface comprises a user-selectable object; and
the non-transitory computer-readable medium further stores computer-executable instructions for:
receiving an indication that the user has selected the user-selectable object; and
at least partially in response to receiving the indication, collapsing at least a portion of the instructional graphical user interface.

17. The non-transitory computer-readable medium of claim 15, further storing computer-executable instructions for:
receiving an indication that the user has completed the first step of the one or more instructions;
at least partially in response receiving the indication that the user has completed the first step of the one or more instructions, determining a second step of the one or more instructions;
at least partially in response to determining the second step of the one or more instructions, determining, based at least in part on the second step of the one or more instructions, a second appropriate graphical user interface on the mobile computing device from which the user may complete the second step of the one or more instructions;
at least partially in response to determining the second appropriate graphical user interface, displaying the second appropriate graphical user interface on the display;
selectively overlaying an instructional graphical user interface over at least a portion of the second appropriate graphical user interface; and
displaying the second step of the one or more instructions on the display via the instructional graphical user interface.

18. The non-transitory computer-readable medium of claim 17, wherein receiving the indication that the user has completed the first step of the one or more instructions comprises substantially automatically determining that the user has completed the first step of the one or more instructions.

19. The non-transitory computer-readable medium of claim 17, wherein:
the instructional graphical user interface comprises a user-selectable step completion object; and
receiving the indication that the user has completed the first step of the one or more instructions comprises receiving an indication that the user has selected the user-selectable step completion object.

20. The non-transitory computer-readable medium of claim 17, wherein the desired action comprises modifying one or more settings on the mobile computing device.
